(19) United States
(12) Patent Application Publication
(10) Pub. No.: US 2014/0278333 A1
(43) Pub. Date: Sep. 18, 2014

(54) SYSTEMS, METHODS, AND MEDIA FOR MODELING TRANSIENT THERMAL BEHAVIOR

(71) Applicant: Arizona Board of Regents, a body corporate of the State of Arizona, acting on behalf of Arizona Sta, Scottsdale, AZ (US)

(72) Inventors: Sandeep Gupta, Phoenix, AZ (US); Georgios Varsamopoulos, Tempe, AZ (US)

(21) Appl. No.: 14/216,322

(22) Filed: Mar. 17, 2014

Related U.S. Application Data
(60) Provisional application No. 61/800,343, filed on Mar. 15, 2013.

(51) Int. Cl. G06F 17/50

(52) U.S. Cl. CPC G06F 17/5009
USPC 703/18

(57) ABSTRACT

In some embodiments, systems for simulating thermal behavior in energy usage simulators are provided, the systems comprising: at least one hardware processor that: induces an event trigger to an environment, wherein the event trigger changes the behavior of the environment; performs computational fluid dynamics simulations on an environment based on a description of the environment to generate transient temperatures; generates a thermal map of the environment; predicts thermal behavior in the environment based on the thermal map; wherein thermal behavior includes division distribution, temporal distribution, and hysteresis; computes physical performance metrics based on the thermal behavior and on efficiency models; generates a resource utilization matrix (RUM) based on both the thermal behavior and workloads of equipment in the environment; generates a computational performance matrix based on the RUM and a supplied performance model; and computes computational performance based on the RUM and on performance models.

### CROSS REFERENCE TO RELATED APPLICATION

This application claims the benefit of U.S. Provisional Patent Application No. 61/800,343, filed Mar. 15, 2013, which is hereby incorporated by reference herein in its entirety.

### STATEMENT REGARDING GOVERNMENT FUNDED RESEARCH

This invention was made with government support under CRI project #0855277, grant #0834797, and grant #1218505 awarded by the National Science Foundation. The government has certain rights in the invention.

### BACKGROUND

Data centers are large and ever expanding users of energy. With the increased usage of Internet and social media, cloud-based services are extending the existing data center roles and are predicted to increase the usage of data centers to unprecedented levels. Data centers already are one of the leading consumers of energy in the US, having increased their energy usage by 56% since 2005, and the new services they will provide only ensure that they will continue to grow. However, a considerable portion of the energy cost of running a data center is avoidable through an intelligent understanding and management of the cyber-physical interactions within them due to their thermal behavior. The idle power usage of equipment is largely beyond the control of data center owners. Considerable savings can be attained by efficiently designing the physical environment, management architectures, and controlling the cyber-physical interactions manifested through heat exchanges between components in the data center.

Energy-efficient data center design and management has been a problem of increasing importance in the last decade due to its potential to save billions of dollars in energy costs. There are several physical (energy) performance metrics, e.g., max power usage, power usage effectiveness (PUE), data center compute efficiency (DCcE), energy reuse efficiency (ERE), and computational performance metrics, e.g., throughput, response delay, turn-around time. However, the design and evaluation of data centers requires designers to be expertly familiar with a prohibitively large number of domain-specific design tools which require user intervention in each step of the design process.

### SUMMARY

Systems, methods, and media for simulating thermal behavior in energy usage simulators are provided.

In some embodiments, systems for simulating thermal behavior in energy usage simulators are provided, the systems comprising: at least one hardware processor that: induces an event trigger to an environment, wherein the event trigger changes the behavior of the environment; performs computational fluid dynamics simulations on an environment based on a description of the environment to generate transient temperatures; generates a thermal map of the environment using the at least one hardware processor; predicts thermal behavior in the environment based on the thermal map; wherein thermal behavior includes division distribution, temporal distribution, and hysteresis; computes physical performance metrics based on the thermal behavior and on efficiency models; generates a resource utilization matrix (RUM) based on both the thermal behavior and workloads of equipment in the environment; generates a computational performance matrix based on the RUM and a supplied performance model; and computes computational performance based on the RUM and on performance models.

In some embodiments, methods for simulating thermal behavior in energy usage simulators are provided, the methods comprising: inducing an event trigger at an environment, wherein the event trigger changes the behavior of the environment; performing computational fluid dynamics simulations on the environment based on a description of the environment to generate transient temperatures; generating a thermal map of the environment using at least one hardware processor; predicting thermal behavior in the environment based on the thermal map; wherein thermal behavior includes division distribution, temporal distribution, and hysteresis; computing physical performance metrics based on the thermal behavior and on efficiency models; generating a resource utilization matrix (RUM) based on both the thermal behavior and workloads of equipment in the environment; generating a computational performance matrix based on the RUM and a supplied performance model; and computing computational performance based on the RUM and on performance models.

In some embodiments, non-transitory computer-readable media containing computer-executable instructions that, when executed by a processor, cause the processor to perform a method for simulating thermal behavior in energy usage simulators are provided, the method comprising: inducing an event trigger at an environment, wherein the event trigger changes the behavior of the environment; performing computational fluid dynamics simulations on the environment based on a description of the environment to generate transient temperatures; generating a thermal map of the environment; predicting thermal behavior in the environment based on the thermal map; wherein thermal behavior includes division distribution, temporal distribution, and hysteresis; computing physical performance metrics based on the thermal behavior and on efficiency models; generating a resource utilization matrix (RUM) based on both the thermal behavior and workloads of equipment in the environment; generating a computational performance matrix based on the RUM and a supplied performance model; and computing computational performance based on the RUM and on performance models.

### BRIEF DESCRIPTION

FIG. 1 is an example of a drawing illustrating cyber-physical interactions that can occur within a data center in accordance with some embodiments.

FIG. 2 is an example of a block diagram of an energy usage simulator in accordance with some embodiments.

FIG. 3 is an example of a block diagram of a computational fluid dynamics simulator module in accordance with some embodiments.

FIG. 4 is an example of an illustration of a heat recirculation matrix in accordance with some embodiments.

FIG. 5 is an example of a block diagram of a cyber-physical simulation engine module in accordance with some embodiments.

FIG. 6 is an example of a block diagram of a resource manager module in accordance with some embodiments.

FIG. 7 is an example of an XML file for describing an environment in accordance with some embodiments.

FIG. 8 is an example of an illustration of an organizing collection structure in accordance with some embodiments.

FIG. 9 is an example of an illustration of corner points of internal object being projected to a reference wall of a room in accordance with some embodiments.

FIG. 10 is an example of an illustration of lines of a reference wall being extruded up to points marking the edge of objects in a room in accordance with some embodiments.

FIG. 11 is an example of the transient model for heat circulation in accordance with some embodiments.

FIG. 12 is an example of hardware that can be used in a server and/or a user device in accordance with some embodiments of the disclosed subject matter.

### DETAILED DESCRIPTION

Systems, methods, and media for simulating thermal behavior in energy usage simulators are provided. In some embodiments, these systems, methods, and media can be used to generate simulations for data centers, using a hardware processor (e.g., as described in connection with FIG. 12).

Turning to FIG. 1, a drawing illustrating cyber-physical interactions that can occur within a data center in accordance with some embodiments is provided. As shown, a data center can include a large number of servers. These servers can be networked to each other, and can share resources such as memory, processors, network bandwidth, and computational load in some embodiments. These servers process or service computational workload as it arrives to the data center through the network. Typical workload may be high-performance computing workload (HPC), such as weather prediction, or it may be transactional service (TS) workload, such as bank database transactions. These servers, as they perform computation, consume electricity and emit heat. In some embodiments, this heat is removed by air-cooling solutions (such data centers are called “air-cooled” data centers). Hot air travels around the data center's environment and eventually enters the chiller unit(s) (chillers are also known as computer room air conditioners (CRACs) or heat ventilation air conditioners (HVACs)).

In some embodiments, the aforementioned physical and computing processes can be captured and a simulation tool can be provided to predict the transient and steady-state temperature and performance of a data center design.

Turning to FIG. 2, an example of a block diagram of a process for providing an energy usage simulator that can be used to model such cyber-physical interactions in a data center in accordance with some embodiments is shown. As illustrated, the process can include a computational fluid dynamics (CFD) simulator module, a Cyber-Physical Simulation Engine (CPSE) module, a Resource Manager (RM) module, an Input Output Manager (IOM) module, and a server database. The process of FIG. 2 can be performed by a hardware processor such as that described in FIG. 12 in some embodiments.

In some embodiments, the computational fluid dynamics (CFD) simulator module can integrate geometry generation, CFD simulations, and post-processing. An example of a block diagram of the CFD simulator module in accordance with some embodiments is shown in FIG. 3. As shown, in some embodiments, the CFD simulator module can include three sub-modules: a pre-processing sub-module; a processing sub-module, and a post-processing sub-module. Processes for the CFD simulator module and its sub-modules can be performed by a hardware processor such as that described in connection with FIG. 12 in some embodiments.

In some embodiments, the pre-processing sub-module can be used to parse a data center physical specification input file and generate a geometry of the data center room and required boundary conditions. The input specification file can be in any suitable format in some embodiments. For example, in some embodiments, the input file can be in the Computer Infrastructure Engineering LAnguage (CIELA) in XML file format (such as that shown, for example, in FIG. 7).

CIELA is a high level XML-based specification language. It has various constructs that capture the generic layout of a data center in order to make it easier for data center designers to use including: (i) equipment configuration, e.g., stacking of servers, chassis power consumption, and air flow rate; (ii) physical data center layout, e.g., presence of raised floors, vented ceilings, perforated tiles and vents. CIELA can be used to abstract the generic design features of a data center, in order to minimize the information required from the user.

The room architecture in CIELA can contain information about the shape of the room including a raised floor, vented ceiling, perforated tiles and hot air return vents. The shape of the room can be described in terms of wall length, height and orientation. The orientation of the first wall can be the reference (x-axis) and the subsequent wall orientation can be with respect to the previous wall mentioned. The components of a data center, e.g., perforated tiles, equipment racks and hot air return vents, can be referred to as objects and all objects can be specified with reference to a wall. A homogeneous collection of objects can form a block and different blocks can be separated by an offset. A set of blocks with same orientation can form a row and a set of rows form a collection. An example of this organizing collection structure is shown in FIG. 8.

The CIELA definition can be broken down into three sections as shown in the example of FIG. 7:
Room Architecture consisting of the wall locations.
Computer Room Air Conditioner (CRAC) which allows the user to specify the position of each CRAC with respect to a named reference wall as well as the unit's type and flow rate.
Equipment consisting of tiles, vents, racks, etc. which are organized using the collection structure discussed above. For blade servers, the user can additionally specify the server model, air flow, and a RackOpening field which defines the direction of air flow through the chassis as being toward or away from a reference wall as 0 or 1 respectively.

In some embodiments, the CIELA specification may specify geometry or other physical characteristics by name and not by description; for example CIELA may allow a user to specify the make and model of a component instead of the dimensions, power and thermal characteristics of servers. This capability may be enabled by including a model library that converts the make-model names into physical descriptions. In some embodiments, this model library may be implemented as a separate XML file; in some embodiments, this model library may be implemented by use of an RDBMS (Relational Data Base Management System).

The XML file can specify the points at the corners of the room and all the internal objects. The corner points of internal objects can then be projected to the reference wall of the room as shown by arrows in FIG. 9. The points on the reference wall can then be connected by lines. These lines can then be “extruded” up to the points marking the edge of objects as shown in FIG. 10 to generate a set of surfaces. These surfaces can be extruded along the height of the room to generate three dimensional volumes.

The geometry can then be converted to a mesh file and the mesh file passed to the processing sub-module in some embodiments. The conversion can be performed in any suitable manner, in some embodiments. For example, the conversion can be performed using GMSH, which is described in Geuzaine, C. and Remacle, J.-F.,“Gmsh: A 3-D finite element mesh generator with built-in pre- and post-processing facilities,” International Journal for Numerical Methods in Engineering 79, 11, 2009, which is hereby incorporated by reference herein in its entirety.

The processing sub-module can receive the mesh file and perform a series of CFD simulations using a hardware processor (e.g., as described in connection with FIG. 12), on the specified data center in some embodiments. A total of n+1 CFD simulations (where n is the number of chassis) can be carried out in some embodiments. Simulations can be carried out with each chassis running at peak power while others run at idle power and a single final simulation can be carried out where all chassis are running at idle power, in some embodiments. The results of the n+1 simulations can then be calibrated by m more CFD simulations, where m is a parameter supplied by the user, in some embodiments. The results of the CFD simulations can then be fed to the post-processing sub-module.

The processing sub-module can be implemented to perform CFD simulations in any suitable manner. For example, in some embodiments, the processing sub-module can be implemented using the OpenFOAM (http://www.openfoam.org) C++ library.

In some embodiments, the post-processing sub-module can then use cross interference profiling to generate an un-calibrated Heat Recirculation Matrix (HRM), using the results of the CFD simulations, in order to obtain steady-state temperature predictions. FIG. 4 shows an example HRM in accordance with some embodiments. The server inlet temperature rise can be predicted by the HRM derived from the n+1 simulations described above, where K is the matrix of heat capacity of air through each chassis and A is the HRM, as follows:

Tᵢₙ^{pred}=Tₛᵤₚ+Dp (1)

where, D=((K−A^{T}K)⁻¹−K⁻¹) (2)

Tᵢₙ^{pred} is a vector representing the predicted air-inlet temperatures at the servers, Tₛᵤₚ is a vector representing the temperature supplied by the CRAC, and p is a vector of power draw from each server.

By comparing the predicted temperature rise Tᵢₙ^{pred} with the temperatures measured by a CFD simulation, the HRM can be calibrated to improve its accuracy in some embodiments. To calibrate the D matrix, any suitable number of CFD simulations can be carried out using utilizations representative of common workloads in some embodiments. For each simulation temperature rise measured by the CFD simulations, a T_{cfd}^{rise} can be recorded in some embodiments. Corresponding rise in temperatures, T_{pred}^{rise}, can then be predicted using the current D matrix. The calibrated D^{new} matrix can be obtained as follows:

$${d}_{ij}^{new} = {d}_{ij} + \frac{{T}_{pred}^{rise} - {T}_{cfd}^{rise}}{{T}_{pred}^{rise} \times n} \times {\sum }_{j = 1}^{n} {d}_{ij} \qquad ( 3 )$$

The newly calibrated HRM can then be sent to the Input Output Manager (IOM) module in some embodiments.

In some embodiments, the post-processing module can use the n CFD simulations results to generate a transient model for heat circulation. The air-inlet temperatures can be predicted by starting the simulations with a steady state temperature T_{const} and then having a single location at a time produce a significant temperature spike. The outlet of all servers can emit the constant temperature such that, Tₒᵤₜⁱ(t)=T_{const}. The observed temperature curves at the air inlets, Tᵢₙ^{j}(t), can be used to calculate division factors, u_{i j} and heat distribution functions, \check{c}_{i j}(T) that incorporate the hysteresis parameter, η, which expresses the delay it takes heat to start arriving at a server.

In other embodiments the heat distribution functions and division factors can be obtained directly, without a CFD solver, if the data is provided by suitable sensors in the data center.

Once the heat distribution functions and division factors are obtained, then the post-processing module can also calculate the temporal contribution curves, c_{i j}=\check{c}_{i j}(−t), each denoting how heat arrives to the air-inlet of a receiving server j from the air outlet of a source server i, and the weighting factors

$${w}_{ij} = {u}_{ij} \frac{{f}_{j}}{{f}_{i}} ,$$

that define how each contributing temperature factors into the actual temperature at the air-inlet of server j. The resulting, contributing temperature of a source server i to a receiving server j can be calculated as follows:

$${\overline{T}}_{ij} = {\int }_{- ∞}^{0} {c}_{ij} ( τ ) {T}_{out}^{i} ( t + τ ) d τ$$

The CPSE module can be used to predict the physical behavior of a data center in response to potential resource management decisions. For example, for each scheduling pattern, the CPSE module can return job response times, server and CRAC power consumption, and a thermal map of the data center, in some embodiments. The HRM can be used by the CPSE module to predict temperatures at one or more points in a data center in some embodiments. Performance models can be used by the CPSE module to predict response times, and power curves can be used by the CPSE to predict server power consumption, in some embodiments.

An example of a block diagram of a CPSE module in accordance with some embodiments is shown in FIG. 5. As illustrated, in some embodiments, the CPSE module can include four sub-modules: a performance sub-module; a thermodynamic sub-module; a power sub-module; and a cooling sub-module. Processes for the CPSE module and its sub-modules can be performed by a hardware processor such as that described in connection with FIG. 12 in some embodiments.

The performance sub-module can be used to calculate response times. These response times can be calculated in any suitable manner. For example, in some embodiments, these response times can be calculated based on a performance model. The performance model can be selected by a user using an Input Output Manager (IOM) user interface, described below.

The performance model can depend on the type of jobs performed. In some embodiments, two different job simulation paradigms can be used for HPC and TS workloads: 1) event based and 2) time discretized, respectively.

In an event based paradigm, a queue of events (event queue) can be maintained, where an event can include the arrival of a new job (job arrival), the beginning of job execution (job start), the end of job execution (job completion), and/or any other suitable event(s). An inter-event interval, which can also be referred to as an event period, can be used to measure the time between two consecutive job start and completion events.

In the time discretized paradigm, the arrival of jobs can be used to define blocks of time and job performance metrics can be defined for each such block of time. Any suitable job performance metrics, such as average arrival frequency and average service time can be computed, and these metrics can be computed in any suitable manner, for example from a probability distribution (e.g., Poisson).

The power sub-module can be used to calculate the total power consumed by each server for a particular utilization in some embodiments. Power consumed can be calculated in any suitable manner. For example, in some embodiments, a Resource Utilization Matrix (RUM) supplied by the RM module (described below), can be used to calculate the power consumed. This RUM can contain any suitable data. For example, in some embodiments, the RUM can contain the server model, the Advanced Configuration and Power Interface (ACPI, http://www.acpi.info/) controlled sleep states (c-states), frequency states (p-states), throttling states (t-states), the utilization of each chassis, and the cooling schedule of CRAC units, for every time epoch.

In some embodiments that utilize the performance sub-module, the RUM can be used to predict computational performance. Computational performance can be measured using metrics such as throughput, response delay or turn-around time. The value of a metric based on the utilization level of a server can be expressed using any suitable analytical and/or numerical method:

performance_metric=f_{method}(utilization_level).

In this way, the RUM can be supplied to a such selected analytical or numerical method to yield the Computational Performance Matrix (CPM):

CPM=f_{method}(RUM).

In some embodiments, there may be an alternative energy source or an energy storage unit. These units may be simulated by a special power sub-module called energy source sub-module. The power consumption can be recorded, which can in turn be used to compute power efficiency metrics.

The power sub-module can query a server database to retrieve a coefficient matrix of the power curve for the particular server model at a given state in some embodiments. To reflect power usage that is a non-linear function of utilization, server power curves can be modeled as configurable 11-element arrays of power consumption at 10% increments, with linear interpolation between points, in some embodiments. These models can be measured directly from a server's under-utilization or can be derived from existing benchmarks, in some embodiments. To perform experiments with hypothetically energy-proportional servers, a simple linear function can be used in some embodiments.

The power consumption matrix can then be calculated based on these constraints and supplied to the thermodynamic sub-module and the cooling sub-module.

A change in server utilization can cause the server power consumption to change to a new value after a time delay. The time delay can depend on the type of server being used and any other suitable factor(s). In some embodiments, when a server utilization changes, the new power consumption value can be stored in a queue for the respective delay period and can then be dispatched after the delay period has completed.

The thermodynamic sub-module can be used to give a thermal map of the data center in some embodiments. The inlet and outlet temperatures for the current time epoch,

Tᵢₙ={Tᵢₙ¹, Tᵢₙ², . . . , Tᵢₙⁿ}, and

Tₒᵤₜ={Tₒᵤₜ¹, Tₒᵤₜ², . . . , Tₒᵤₜⁿ}

respectively, for each chassis can be calculated for the steady-state model as follows:

Tₒᵤₜ=Tₛᵤₚ+(K−A^{T}K)⁻¹p, and

Tᵢₙ=Tₒᵤₜ−K⁻¹p. (4)

where Tₛᵤₚ is the CRAC supply temperature, K is the matrix of heat capacity of air through each chassis and A is the HRM.

Continuing, in accordance with some embodiments, the inlet temperatures for the current time epoch for each chassis can be calculated for the transient state model based on the convex weighted sum of the temperature contributions of all servers and CRAC as they accumulate over time from the past, as follows:

$${T}_{in}^{j} ( t ) = {\sum }_{i = 1}^{n} {w}_{ij} {\overline{T}}_{ij} ( t )$$

where T̅ᵢⱼ(t) is the resulting, contributing temperature of a source server i to a receiving server j and the weighting factors should follow Σᵢ₌₁ⁿw_{i j}=1, ∀j.

An example of a diagram of the transient behavior for heat circulation in accordance with some embodiments is shown in FIG. 11.

Tᵢₙ and Tₒᵤₜ together can constitute a thermal map of the data center. This thermal map can be sent to the RM module in a feedback loop, and stored in memory (e.g., such as memory 1204 described in connection with FIG. 12).

The cooling sub-module can be used to calculate cooling power in some embodiments. This cooling power can be calculated in any suitable manner. For example, in some embodiments, cooling power can be calculated using one or more cooling models.

In some embodiments, a dynamic cooling model can be used. In some embodiments, a dynamic cooling model can account for two basic modes of operation: high mode and low mode. Based on the CRAC inlet temperature, the mode can be switched between high mode and low mode to extract p^{high} and p^{low} amount of heat, respectively. If the CRAC inlet temperature, T_{CRAC}ⁱⁿ, crosses a higher threshold temperature, T_{high}^{th}, the high mode can be triggered and if T_{CRAC}ⁱⁿ crosses a lower threshold temperature, T_{low}^{th}, the low mode can be triggered. The threshold temperatures can be supplied by the user through the IOM module, discussed below. In some embodiment, the new CRAC mode can be delayed by a user specified time delay based on its type.

In some embodiment, a constant cooling model can be used. In some embodiments, a constant cooling model can assume that a supply temperature, Tₛᵤₚ, is constant. Thus, in such a case, regardless of the inlet temperature to the CRAC, the outlet temperature can match a user specified value.

In some embodiments, an instantaneous cooling model can be used. In some embodiments, an instantaneous cooling model can adjust a cooling load based on a total heat added by IT equipment and redline temperatures of the IT equipment.

In some embodiments, a cooling model can be user defined.

In some embodiments, the CPSE module can output a combination of power-model parameters, thermodynamic-model parameters, performance-model parameters, and cooling-model parameters into a log file and providing them as feedback to the RM module and the IOM module.

The Resource Manager (RM) module can be used to make informed decisions about workload, cooling, and power management based on the physical behavior of the data center. The RM can use various management schemes that receive feedback from the CPSE module, which can predict the physical impact of the RM's management decisions.

Any suitable RM module can be used in some embodiments. For example, as shown in FIG. 6, in some embodiments, the RM module can include: (a) a workload management algorithm, (b) a power management algorithm, (c) a cooling management algorithm, and (d) a coordinated workload, power, and cooling management algorithm. Processes for the RM module can be performed by a hardware processor such as that described in connection with FIG. 12 in some embodiments.

The use of these algorithms can be triggered by any suitable events in some embodiments. For example, in some embodiments, the use of these algorithms can be triggered by two types of events: HPC job arrival events for HPC data centers; and timeout events for Internet or transactional data centers (IDC). Transactional workloads are continuous in nature and require decision making at different granularities of time: (i) long-time decision making on the active server set for peak load during coarsely granular long time epoch; and (ii) short-time decision making on percentage load distribution to the active servers based on the average load during the finely granular short time interval.

To support such time based decision making, the RM module can maintains two timers. When these timers expire, the RM module can trigger long-time and short-time decision making, respectively. Such multi-tier resource management can be used in some embodiments to address: (i) different resources in the system having different state transition delays—for instance, processors may require more wake-up time for higher c-state numbers (http://cs466.andersonje.com/public/pm.pdf); and (ii) the variation of transactional workload such as Web traffic being very high, unpredictable, exhibiting hourly/minute cyclic behavior.

Apart from the timer events, the RM module can listen for HPC job arrival events from the IOM module.

The workload management algorithm can be used to select when and where to place workload. For HPC workload, this selection can involve the scheduling and placement of specific jobs when HPC job arrival events occur; while for IDCs, this selection can involve distribution of requests (i.e., the short-time decision making) among servers. In some embodiments, rank-based workload management algorithms, control-based workload management algorithms, optimization-based workload management algorithms, and/or any other suitable workload management algorithms can be used.

A rank-based workload management algorithm can assign ranks to servers and place (or distribute) workload based on the ranks of the servers.

A control-based workload management algorithm can closely track performance parameters (e.g., response time) of jobs and then control the workload arrival rate to get a desired response time. Such a control-based workload management algorithm can be used when an accurate model of the system in a certain interval can be made.

An optimization-based workload management algorithm can solve an optimization problem or can select a best solution from a set of feasible solutions, in order to schedule and place workload, and/or to select an active server set.

The power management algorithm can be used to control the power mode of a system or different components inside the system in some embodiments. For example, in some embodiments, energy can be saved by transitioning to lower power states of system/components when the workload is low, or to achieve a certain power capping goal. Power management at the system level can include sleep state transition and dynamic server provisioning in some embodiments. Depending on the time granularity, the power manager can put servers to sleep or power them down as workload varies, in some embodiments. CPU power management can include c-state management that controls CPU sleep state transition and p-state management (e.g., dynamic voltage and frequency scaling (DVFS)). In a specific power state, the DVFS of the CPU can be of interest because energy can be saved by scaling the CPU frequency. Both control theory based approaches and optimization based approaches can be used for power management in some embodiments.

The cooling management algorithm can be used to control the thermostat settings of the cooling units in some embodiments. Any suitable approach for controlling the thermostat settings can be used in some embodiments. For example, a static approach (e.g., constant pre-set thermostat setting) or dynamic approach (e.g., a schedule of thermostat settings depending on events) can be used in some embodiments.

In some embodiments, a combined management algorithm can be used. For example, in some embodiments, a combined management algorithm can integrate decision making of workload, power, and cooling management. Combined management can be ranking based, control based, and/or optimization based in some embodiments. For control-based and/or optimization-based management, control and optimization variables (respectively) can increase for a combined algorithm. For ranking-based combined management, the ranking mechanism can take into account the interplay between workload, power, and cooling.

In some embodiments, a management scheme can be chosen by the user using an IOM module (described below).

The output from the RM module can include: active server set, e.g., the set of servers which are not in a sleep state; workload schedule, e.g., job start times; workload placement, e.g., assignment of jobs for HPC workload and percentage distribution of requests for transactional workload; power modes, e.g., clock frequency of the server platforms in the active server set; and cooling schedule, e.g., the highest thermostat settings of cooling units permitted by each chassis while avoiding redlining. Depending on this cooling schedule, the CPSE can set the CRAC thermostat to the lowest value. These outputs can be compiled together to form a Resource Utilization Matrix (RUM) and sent to the CPSE module for each time epoch/event. The structure of the RUM can be: (chassis list, utilization, c-state, p-state, t-state, workload tag, server type, cooling schedule), where the chassis list includes the names of the chassis in a given format, the utilization is the percentage utilization, the c-state, the p-state, the t-state are the sleep, frequency and throttling states (respectively), the workload tag describes the type of workload (e.g., HPC or transactional), the server type is the model of the server(s), and the cooling schedule is the schedule used by the CPSE to set the CRAC thermostat, of each chassis for the particular time epoch/event.

The Input Output Manager (IOM) module can be used to serve as a user interface. User inputs can include: job trace (λ), Service Level Agreements (SLAs), management schemes, a queuing model, and/or any other suitable inputs.

The job trace can define the characteristics of the workload supplied to the data center.

The SLA requirements can define the requirements (e.g., based on response time) of Service Level Agreements with customers of the data center. The response times output by the CPSE module can be checked against the supplied SLA requirements for SLA violations and any such violations can be reported to the RM module.

Management schemes can include: (i) power management schemes; (ii) workload management schemes; and (iii) cooling characteristic schemes.

Workload tags can be attached to a job to distinguish between HPC and transactional job types. Based on this distinction the RM module and the CPSE module can use either an event-based or a time-discretized simulation paradigm for HPC or transactional workloads respectively.

The performance model for response time computation can be supplied to the CPSE module by the IOM module in some embodiments.

The IOM module can also store an array of HRMs for a data center for different active server sets and provide an HRM when needed, in some embodiments. Based on the feedback from the RM module and the CPSE module, the IOM can provide an appropriate HRM.

In some embodiments, an HRM can be used to predict the temperature rise of servers' inlets due to heat recirculation. A data centers' cooling energy can be affected by that temperature rise. In other words, cooling energy can depend on the CRAC's CoP which is usually a super linear and monotonically increasing function of the supplied temperature Tₛᵤₚ. The highest CRAC supplied temperature can be limited by the servers' redline temperature. Therefore, Tₛᵤₚ can be limited to:

Tₛᵤₚ=T^{red}−max(Dp) (5)

where T^{red} is the redline temperature of a server, and max(Dp) is the maximum permitted temperature rise of the server. The cooling power, denoted by p^{AC}, can be written as:

$${P}^{A C} = \frac{{p}^{comp}}{CoP ( {T}^{red} - max ( Dp ) )} \qquad ( 6 )$$

where p^{comp} denotes the total computing power.

In accordance with some embodiments, an example of a usage of a simulator as described herein, can be found in Zahra Abbasi, Tridib Mukherjee, Georgios Varsamopoulos, and Sandeep K. S. Gupta, “DAHM: A green and dynamic web application hosting manager across geographically distributed data centers,” ACM Journal on Emerging Technologies in Computing Systems (JETC), Volume 8, Issue 4, October 2012 (Article No. 34), which is hereby incorporated by reference herein in its entirety. This paper uses a configuration of a simulator which considers virtualized servers distributed across different data center locations. The power sub-module uses a series of linear power consumption models to capture the hardware heterogeneity, the cooling sub-module uses a quadratic equation, and the performance sub-module uses GI/G/m queuing model equations. Also various HRMs were used to demonstrate the layout heterogeneity.

The power sub-module may then compute the overall energy consumption, by integrating the computing and cooling power consumption over the simulation time. In some embodiments, the power sub-module may compute the physical performance metrics, e.g. PUE:

PUE=P_{computing}+Pₙₒₙ_{_{—}}_{computing}/P_{computing}

In some embodiments, a graphical front user interface (GUI) which will allow a user to interact with the software can be provided. Capabilities of the GUI may include uploading of XML documents, starting, stopping and managing of simulations, gathering of results, etc. In some embodiments, this GUI may be implemented through a Web/HTML interface.

In some embodiments, simultaneous execution of multiple simulations can be provided. In those embodiments, a cluster management architecture to dispatch and collect simulation tasks can be provided.

In some embodiments, installations may feature an accounting component in which users have to provide login credentials to access the tool. An accounting component may be used to protect and secure files and work on a per-account basis and may disallow access to users on files that do not belong to their accounts.

In accordance with some embodiments, any suitable hardware can be used to implement the mechanisms described herein. For example, as illustrated in example hardware 1200 of FIG. 12, such hardware can include a hardware processor 1202, memory and/or storage 1204, an input device controller 1206, an input device 1208, display/audio drivers 1210, display and audio output circuitry 1212, communication interface(s) 1214, an antenna 1216, and a bus 1218.

Hardware processor 1202 can include any suitable hardware processor, such as a microprocessor, a micro-controller, digital signal processor, dedicated logic, and/or any other suitable circuitry for controlling the functioning of a general purpose computer or special purpose computer in some embodiments.

Memory and/or storage 1204 can be any suitable memory and/or storage for storing programs, data, information of users and/or any other suitable content in some embodiments. For example, memory and/or storage 1204 can include random access memory, read only memory, flash memory, hard disk storage, optical media, and/or any other suitable storage device.

Input device controller 1206 can be any suitable circuitry for controlling and receiving input from one or more input devices 1208 in some embodiments. For example, input device controller 1206 can be circuitry for receiving input from a touch screen, from one or more buttons, from a voice recognition circuit, from a microphone, from a camera, from an optical sensor, from an accelerometer, from a temperature sensor, from a near field sensor, from an energy usage sensor, and/or any other suitable circuitry for receiving input.

Display/audio drivers 1210 can be any suitable circuitry for controlling and driving output to one or more display and audio output circuitries 1212 in some embodiments. For example, display/audio drivers 1210 can be circuitry for driving an LCD display, a speaker, an LED, and/or any other display/audio device.

Communication interface(s) 1214 can be any suitable circuitry for interfacing with one or more communication networks. For example, interface(s) 1214 can include network interface card circuitry, wireless communication circuitry, and/or any other suitable circuitry for interfacing with one or more communication networks.

Antenna 1216 can be any suitable one or more antennas for wirelessly communicating with a communication network in some embodiments. In some embodiments, antenna 1216 can be omitted when not needed.

Bus 1218 can be any suitable mechanism for communicating between two or more of components 1202, 1204, 1206, 1210, and 1214 in some embodiments.

Any other suitable components can be included in hardware 1200 in accordance with some embodiments.

In some embodiments, any suitable computer readable media can be used for storing instructions for performing the processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

The systems, methods, and media for simulating thermal behavior in energy usage simulators can be used for any suitable purpose. For example, in some embodiments, the systems, methods, and media can be used in connection with data centers. More particularly, in some embodiments, these systems, methods, and media can be used by data center designers to study the transient and steady-state thermal effects of data centers' configurations, computing infrastructure, and cooling units. CIELA can be used to describe layouts of data centers along with location of server racks, computing equipment and CRAC units. Energy efficiency analysis of a proposed design can then be performed under different management schemes. The data center can then be redesigned until all the design goals are met. Similarly, in some embodiments, an algorithm developer can use the feedback loops provided by the CPSE module to develop and evaluate physical aware resource management algorithms and incorporate them in the Resource Manager module. Also, in some embodiments, a data center operator can conduct performance analyses of different data center configurations, computing equipment, cooling units, and/or management algorithms and suggest changes if required.

Although the invention has been described and illustrated in the foregoing illustrative embodiments, it is understood that the present disclosure has been made only by way of example, and that numerous changes in the details of implementation of the invention can be made without departing from the spirit and scope of the invention, which is only limited by the claims which follow. Features of the disclosed embodiments can be combined and rearranged in various ways.

What is claimed is:

1. A system for simulating thermal behavior in energy usage simulators, comprising:
at least one hardware processor that:
induces an event trigger at an environment, wherein the event trigger changes the behavior of the environment;
performs computational fluid dynamics simulations on the environment based on a description of the environment to generate transient temperatures;
generates a thermal map of the environment;
predicts thermal behavior in the environment based on the thermal map; wherein thermal behavior includes division distribution, temporal distribution, and hysteresis;
computes physical performance metrics based on the thermal behavior and on efficiency models;
generates a resource utilization matrix (RUM) based on both the thermal behavior and workloads of equipment in the environment;
generates a computational performance matrix based on the RUM and a supplied performance model; and
computes computational performance based on the RUM and on performance models.

2. The system of claim 1, wherein the environment is a data center.

3. The system of claim 1, wherein the equipment is at least one server in the environment.

4. The system of claim 1, wherein the description of the environment is received as an XML file.

5. The system of claim 1, wherein the resource utilization matrix indicates active equipment in the environment.

6. A method for simulating thermal behavior in energy usage simulators, comprising:
inducing an event trigger at an environment, wherein the event trigger changes the behavior of the environment;
performing computational fluid dynamics simulations on the environment based on a description of the environment to generate transient temperatures;
generating a thermal map of the environment using at least one hardware processor;
predicting thermal behavior in the environment based on the thermal map;
wherein thermal behavior includes division distribution, temporal distribution, and hysteresis;
computing physical performance metrics based on the thermal behavior and on efficiency models;
generating a resource utilization matrix (RUM) based on both the thermal behavior and workloads of equipment in the environment;
generating a computational performance matrix based on the RUM and a supplied performance model; and
computing computational performance based on the RUM and on performance models.

7. The method of claim 6, wherein the environment is a data center.

8. The method of claim 6, wherein the equipment is at least one server in the environment.

9. The method of claim 6, wherein the description of the environment is received as an XML file.

10. The method of claim 6, wherein the resource utilization matrix indicates active equipment in the environment.

11. A non-transitory computer-readable medium containing computer-executable instructions that, when executed by a processor, cause the processor to perform a method for simulating thermal behavior in energy usage simulators, the method comprising:
inducing an event trigger at an environment, wherein the event trigger changes the behavior of the environment;
performing computational fluid dynamics simulations on the environment based on a description of the environment to generate transient temperatures;
generating a thermal map of the environment;
predicting thermal behavior in the environment based on the thermal map;
wherein thermal behavior includes division distribution, temporal distribution, and hysteresis;
computing physical performance metrics based on the thermal behavior and on efficiency models;
generating a resource utilization matrix (RUM) based on both the thermal behavior and workloads of equipment in the environment;
generating a computational performance matrix based on the RUM and a supplied performance model; and
computing computational performance based on the RUM and on performance models.

12. The non-transitory computer readable medium of claim 11, wherein the environment is a data center.

13. The non-transitory computer readable medium of claim 11, wherein the equipment is at least one server in the environment.

14. The non-transitory computer readable medium of claim 11, wherein the description of the environment is received as an XML file.

15. The non-transitory computer readable medium of claim 11, wherein the resource utilization matrix indicates active equipment in the environment.
